(19) United States
(12) Patent Application Publication
(10) Pub. No.: US 2010/0101366 A1
(43) Pub. Date: Apr. 29, 2010

(54) FOUR WHEEL DRIVE POWERTRAIN

(76) Inventor: Thomas E. Braford, Brighton, MI (US)

Correspondence Address: WARN, HOFFMANN, MILLER & OZGA, P.C., P.O. BOX 70098, ROCHESTER HILLS, MI, 48307, US

(21) Appl. No.: 12/594,068

(22) PCT Filed: Apr. 2, 2008
(86) PCT No.: PCT/US08/04289

§ 371 Date: Sep. 30, 2009

Related U.S. Application Data
(60) Provisional application No. 60/922,284, filed on Apr. 6, 2007.

(51) Int. Cl. F16H 37/08; B60K 17/34

(52) U.S. Cl. 74/665 G

(57) ABSTRACT

An arrangement 7 of a powertrain for a four wheel drive vehicle with a dual clutch transmission is provided including a longitudinal mounted engine 10 with an output shaft 13 extending rearward from the engine 10, a dual clutch transmission 30 having inner and outer geared input shafts 50, 40 generally coaxial with the engine output shaft 13; an output shaft 80 having a plurality output gears operatively associated with gears of the input shafts 50, 40, a clutch module 20 connected with the transmission 30, the clutch module mounting a dual clutch assembly 14 for selectively connecting the inner and outer input shafts 50, 40 with the engine output shaft 13. A rear differential 40 is powered from a rear end of the output shaft 80 and a front differential 120 is powered from a front end of the output shaft 80.

### FIELD OF THE INVENTION

The present invention relates to powertrain arrangements for all wheel drive vehicles having dual clutch transmissions.

### BACKGROUND OF THE INVENTION

In many premium vehicles having a high horsepower engine, to obtain maximum traction of the wheels, an all wheel drive powertrain is essential. It is desirable to provide such a powertrain that additionally provides the advantages of a dual clutch transmission similar to those described in U.S. Pat. Nos. 5,711,409; 6,996,989; 6,887,184; 6,909,955; and Patent Applications 2006/0101933A1; and 2006/0207655A1.

### SUMMARY OF THE INVENTION

To make manifest the above noted and other manifold desires, a revelation of the present invention is brought forth. In one preferred embodiment, the present invention provides an arrangement of a powertrain for a four wheel drive vehicle with a dual clutch transmission including a longitudinal mounted engine with an output shaft extending rearward from the engine, a dual clutch transmission having inner and outer geared input shafts generally coaxial with the engine output shaft, an output shaft having a plurality output gears operatively associated with gears of the input shafts, a clutch module connected with the transmission, the clutch module mounting a dual clutch assembly for selectively connecting the inner and outer input shafts with the engine output shaft. A rear differential is powered from a rear end of the output shaft and a front differential is powered from a front end of the output shaft.

### BRIEF DESCRIPTION OF THE DRAWINGS

The present invention will become more fully understood from the detailed description and the accompanying drawings, wherein:

FIG. 1 is a schematic view of an embodiment powertrain arrangement of the present invention wherein a transmission is connected to an engine;

FIG. 2 is a schematic view of an embodiment of the present invention wherein a transmission is connected with a rear differential;

FIG. 3 is a sectional view of an embodiment of the present invention wherein a transmission is connected with the engine with the front and rear differentials being removed for clarity of illustration;

FIG. 4 is an enlargement of a main dual clutch shown in FIG. 3; and

FIGS. 5, 6, and 7 are alternative embodiment clutch modules to those shown in the schematics of FIGS. 1 and 2.

### DETAILED DESCRIPTION OF THE PREFERRED EMBODIMENTS

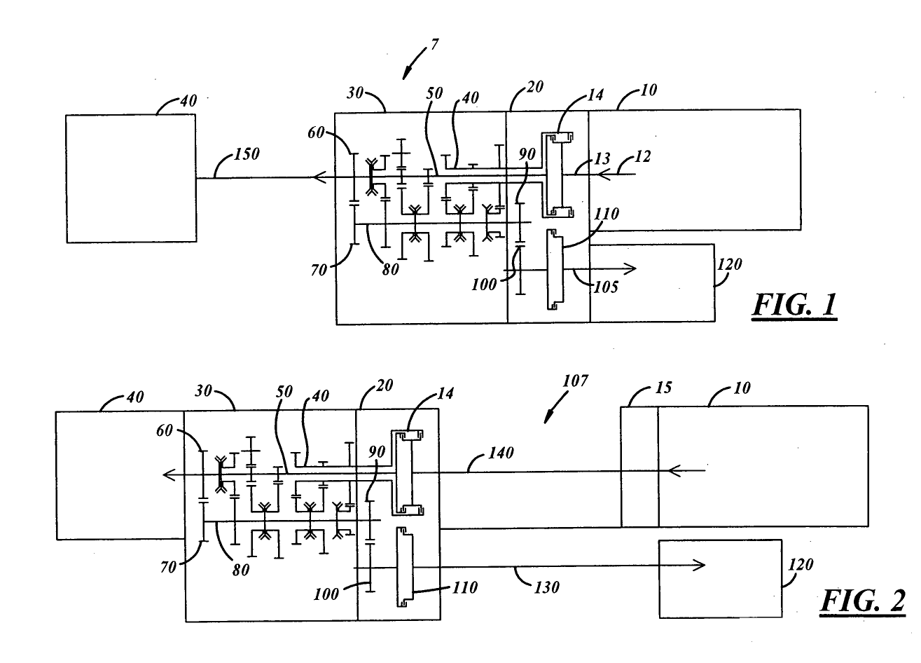

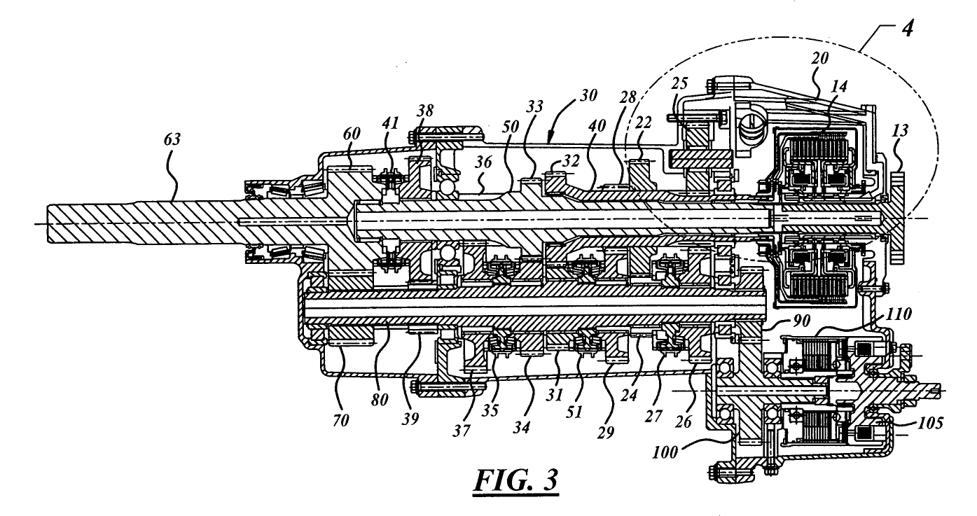

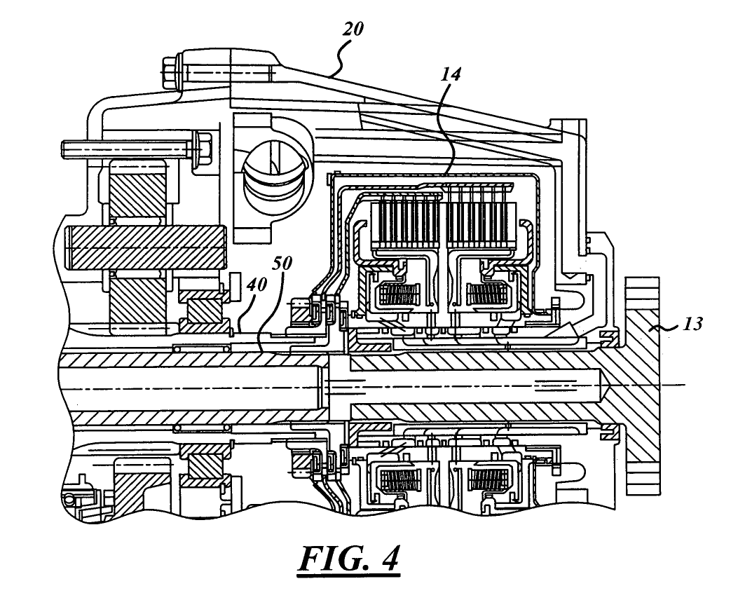

Referring primarily to FIGS. 3 and 4 and additionally to FIG. 1, a powertrain arrangement 7 of the present invention includes an engine 10. The engine 10 is mounted longitudinally and has a rear extending output shaft 12. The output shaft 12 is torsionally connected directly or via damper with a main clutch input shaft 13. Shaft 13 is splined to a hub of a main clutch provided by a dual clutch 14. The clutch 14 has housings splined to an inner input shaft 50 and an outer input shaft 40.

A counter shaft gear 25 is meshed with the input shaft 40 which in turn meshes with a ratio defining output gear 26. Note, the rotational axis of shafts 40 and 80, and gear 25, and not coplanner as shown. The output gear 26 typically spins freely on the output shaft 80. A synchronizer 27 actuated to the right position connects the output gear 26 with the output shaft 80 providing a reverse gear of the transmission 30. Torsionally fixed on the outer input shaft 40 is a ratio defining input gear 22. Input gear 22 meshes with the output gear 24. If synchronizer 27 is actuated to the left to connect output gear 24 with output shaft 80, transmission 30 will be in the fifth gear ratio. Input shaft 40 also mounts input gear 28. Input gear 28 is in meshed relationship with a ratio defining output gear 29. A synchronizer 51 actuated to the right connects output gear 29 with the output shaft 80 to provide a second gear ratio for the transmission 30. Input shaft 40 additionally mounts an input gear 32. Input gear 32 meshes with a ratio defining output gear 31. Actuation of synchronizer 51 to the left connects input gear 31 with output shaft 80 to provide a fourth gear ratio of the transmission 30. Output shaft 50, which along with input shaft 40, is coaxial with the engine output shaft 12. Output shaft 50 mounts an input gear 33. Input gear 33 meshes with a ratio defining output gear 34. Actuation of synchronizer 35 to the right connects output gear 34 with the output shaft 80 to provide a third gear ratio of the transmission 30. A gear tooth portion 36 of the input shaft 50 meshes with an output gear 37. Actuation of the synchronizer 35 to the left connects the output gear 37 with the output shaft 80 to provide a first gear ratio of the transmission 30. Ratio defining input gear 38 is also provided on the input shaft 50. Input gear 38 meshes with an output gear 39 providing a sixth gear ratio of the transmission 30 when the synchronizer 41 is actuated to the right.

A left (rear) end of the output shaft 80 is torsionally connected with a gear 70. Gear 70 meshes with a gear 60 which has an integral stem 63 which is connected to a prop shaft 150, which is in turn connected with the rear differential 40. A front end of the output shaft 80 has connected thereto a gear 90. Gear 90 meshes with a coupling gear 100. Coupling gear 100 provides an input to a coupling clutch 110. Coupling clutch 110 has an output shaft 105 which is torsionally connected with the front differential 120. In the embodiment shown in FIGS. 1 and 3, the torsional connection between the coupling clutch 110 and the front differential 120 is not exposed since the clutch module 20 directly connects the front differential.

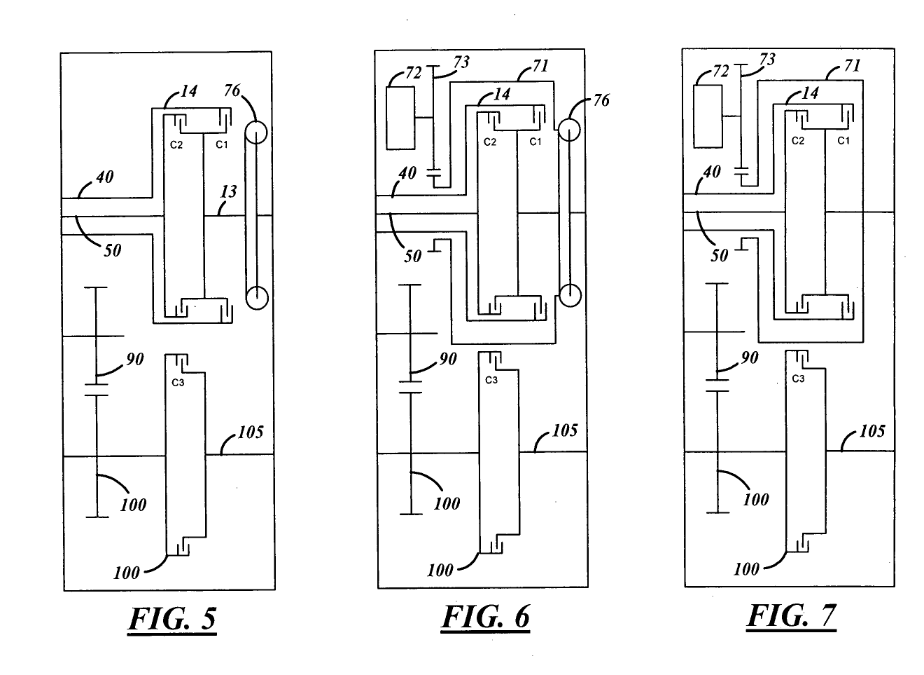

FIG. 2 illustrates an embodiment 107 of the present invention wherein the clutch module 20 and transmission 30 are directly connected with the rear differential 40 of the vehicle. A prop shaft 140 extends from the engine 10 to the clutch module 20. In the embodiment 107 there is a damper 15 juxtaposed between the engine and the prop shaft 140. A second prop shaft 130 is provided which extends between the coupling clutch 110 and the front differential 120. FIG. 5 illustrates an embodiment of the present invention wherein the clutch module additionally has a damper 76 which is connected with the input shaft 13 of the main clutch 14. FIG. 6 illustrates an embodiment the present invention having the previously mentioned damper 76 and also having a gear 71 that is meshed with a gear 73 which powers a lubricant pump 72. FIG. 7 is a view similar to that of FIG. 6 wherein the damper is deleted, however, there is still a gear 71 which is meshed with the gear 73 which powers the pump 72. The clutch modules shown in FIGS. 5, 6, and 7 if desired can be substituted for the clutch modules shown in FIGS. 1 and 2.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

What is claimed is:

1. A powertrain arrangement for an all wheel drive vehicle with a longitudinal mounted engine and a dual clutch transmission comprising:
a longitudinal mounted engine with an output shaft extending rearward from said engine;
a dual clutch transmission having inner and outer geared input shafts generally coaxial with said engine output shaft;
an output shaft having a plurality output gears operatively associated with gears of said input shafts;
a clutch module connected with said transmission, said clutch module mounting a dual clutch assembly for selectively connecting said inner and outer input shafts with said engine output shaft; and
wherein a rear differential is powered from a rear end of said output shaft and a front differential is powered from a front end of said output shaft.

2. An arrangement as described in claim 1 wherein said clutch module further mounts a coupling clutch for powering said front differential from said output shaft.

3. An arrangement as described in claim 1 wherein said clutch module is directly connected to said engine.

4. An arrangement as described in claim 1 wherein said clutch module is directly connected to said front differential.

5. An arrangement as described in claim 4 wherein an input shaft to said front differential is non-exposed.

6. An arrangement as described in claim 1 wherein said clutch module includes a damper.

7. An arrangement as described in claim 1 wherein said clutch module includes a damper and a pump.

8. An arrangement as described in claim 1 wherein said clutch module includes a pump.

9. An arrangement as described in claim 1 wherein said dual clutch is powered through its hub.

10. An arrangement as described in claim 1 wherein said transmission is connected with said rear differential.

11. A powertrain arrangement for an all wheel drive vehicle with a longitudinal mounted engine and a dual clutch transmission comprising:
a longitudinal mounted engine with an output shaft extending rearward from said engine;
a dual clutch transmission having inner and outer geared input shafts generally coaxial with said engine output shaft;
an output shaft having a plurality of output gears operatively associated with gears of said input shafts;
a front differential;
a clutch module connected with said engine said front differential, and said transmission, said clutch module mounting a dual clutch assembly for selectively connecting said inner and outer input shafts with said engine output shaft, and said clutch module further mounting a coupling for powering said front differential from said output shaft; and
wherein a rear differential is powered from a rear end of said output shaft and said front differential is powered from a front end of said output shaft.

12. A powertrain arrangement for an all wheel drive vehicle with a longitudinal mounted engine and a dual clutch transmission comprising:
a longitudinal mounted engine with an output shaft extending rearward from said engine;
a dual clutch transmission connected with a rear differential, said dual clutch transmission having inner and outer geared input shafts generally coaxial with said engine output shaft;
an output shaft having a plurality of ratio defining output gears operatively associated with gears of said input shafts;
a clutch module connected with said transmission, said clutch module mounting a dual clutch assembly for selectively connecting said inner and outer input shafts with said engine output shaft, and said clutch module further mounts a coupling clutch for powering a front differential from said output shaft; and
wherein a rear differential is powered from a rear end of said output shaft and said front differential is powered from a front end of said output shaft.
